(19) United States
(12) Patent Application Publication
(10) Pub. No.: US 2017/0361564 A1
(43) Pub. Date: Dec. 21, 2017

(54) DAMPENED CREPING BLADE

(71) Applicant: Kimberly-Clark Worldwide, Inc., Neenah, WI (US)

(72) Inventors: Robert James Seymour, Appleton, WI (US); Richard Mark Hansen, Oshkosh, WI (US)

(21) Appl. No.: 15/524,065

(22) PCT Filed: Dec. 18, 2015
(86) PCT No.: PCT/US2015/066708

§ 371 Date: May 3, 2017

Related U.S. Application Data
(60) Provisional application No. 62/097,947, filed on Dec. 30, 2014.

(51) Int. Cl. B31F 1/14; B31D 1/04; A47K 10/16

(52) U.S. Cl. CPC B31F 1/14; B31D 1/04; A47K 10/16

(57) ABSTRACT

The present invention is generally directed to a doctor blade comprising a blade, a backing member or material and a viscoelastic material disposed there between. The doctor blades of the present invention overcome many of the limitations of prior art doctor blades, namely the reduction of blade vibration and the resulting damage caused to dryer surfaces. The creping blades and doctor blades of the present invention can be used for any purpose and should not be considered to be limited to the examples set forth herein.

### BACKGROUND OF THE DISCLOSURE

In the manufacture of paper products, and particularly creped tissue products, the nescient paper web is often adhered to a cylindrical dryer, such as a Yankee Dryer, dried and then removed from the dryer surface using a blade. The blade used to remove the web from the dryer is typically referred to as a doctor blade or a creping blade. The composition of the creping blade may vary; however, they are typically designed to be durable, withstanding loading against the dryer surface, and to minimize damage to the dryer surface.

Yankee dryers generally comprise large-scale drums, typically formed of cast iron, which are internally heated with pressurized steam and used to dry the nescient paper web. In operation the creping blade is loaded against the surface of the Yankee dryer in order to scrap the paper web from the dryer surface. The loading of the blade against the surface of the dryer causes friction, which causes the surface to wear. Surface wear can lead to surface imperfection, such as surface roughness, which may cause the creping blade to vibrate. The vibrating creping blade can then further wear the dryer surface. To avoid this, the dryers must be periodically reground and repolished as surface imperfections become significant. Resurfacing of the dryer by grinding and polishing is costly in downtime, lost paper production, and in charges for overhaul of the dryer drum surface.

Several solutions to the problem of dryer surface wear have been proposed, however, these solutions largely focus upon the dryer surface. For example, U.S. Pat. No. 4,822,415 describes thermal spray alloys, which provide a hard and corrosion resistant surface. U.S. Pat. No. 4,389,251 describes a similar solution, however, proposes the spray application of two-alloys—a nickel-based alloy and an iron-based alloy. These solutions, while improving dryer surface durability have not eliminated the need for dryer resurfacing and have not solved the problem of creping blade vibration once the surface begins to wear. Therefore there remains a need in the art for a creping solution that minimizes creping blade vibration, reduces dryer surface wear and reduces the need to recondition or resurface the dryer.

### SUMMARY OF THE DISCLOSURE

The present invention provides dampened doctor and creping blades that provide effective constrained-layer damping at high operating temperatures and retain that effectiveness after prolonged exposure to the high temperatures. Without being bound by theory it is believed the addition of the viscoelastic material, which in a preferred embodiment is constrained between a blade and a backing layer of similar composition, alters the resonant frequency of the blade thereby reducing instances of erratic and excessive blade vibration, improving blade life and reducing instances of dryer damage. Accordingly, in one embodiment the present disclosure provides a doctor blade comprising a blade, a backing layer and a viscoelastic material constrained between the blade and the backing layer.

In other embodiments the present invention provides a dampened creping blade comprising a blade having a first end and a second end, the first end forming a tip for contacting the dryer surface and the second end forming a blade clamping end for fastening the blade to a blade holder, a backing layer positioned away from the dryer surface and a viscoelastic material disposed between the blade and the backing layer.

In another embodiment the present invention provides a damped creping blade comprising a blade, a layer of viscoelastic material adhered to one major surface of the blade and a backing layer disposed over and coextensive with the viscoelastic material, wherein the length of the viscoelastic material and the backing layer are less than the length of the blade.

In still other embodiments the present invention provides a creping apparatus for creping a web of tissue from a creping cylinder comprising a holder and a creping blade comprising a blade having a tip and a blade clamping end and a length L1, a backing layer having a length L2 and a layer of viscoelastic material disposed between the blade and the backing layer, wherein L1 is greater than L2.

In yet other embodiments the present invention provides a method of reducing creping blade vibration during the creping of a tissue web comprising the steps of providing a creping blade comprising a blade having a tip and a blade clamping end and a length L1, a backing layer having a length L2 and a layer of viscoelastic material disposed between the blade and the backing layer, wherein L1 is greater than L2, retaining the creping blade in a blade holder, conveying a tissue web across the surface of a creping cylinder and urging the creping blade against the surface of the creping cylinder thereby removing the tissue web therefrom with reduced creping blade vibration.

### BRIEF DESCRIPTION OF DRAWINGS

FIG. 1 is a cross-sectional view of one embodiment of the creping blade according to the present invention;

FIG. 2 is a schematic diagram of one embodiment of the creping blade according to the present invention in-use;

FIG. 3 is a schematic diagram of the creping system according to one embodiment of the present invention; and

FIG. 4 is a schematic diagram of the creping system according to an alternate embodiment of the present invention.

Repeat use of reference characters in the present specification and drawings is intended to represent the same or analogous features or elements of the disclosure.

### DETAILED DESCRIPTION OF THE DISCLOSURE

The present invention is generally directed to a doctor blade comprising a blade, a backing member or material and a viscoelastic material disposed there between. The doctor blades of the present invention overcome many of the limitations of prior art doctor blades, namely the reduction of blade vibration and the resulting damage caused to dryer surfaces. The creping blades and doctor blades of the present invention can be used for any purpose and should not be considered to be limited to the examples set forth herein. The creping blades generally have the same geometry as doctor blades. Doctor blades are typically used to help remove a material from the surface of a piece of equipment, wherein the surface of the piece of equipment moves past the blade or the blade moves over the surface of the piece of equipment on which the material to be removed is disposed. Often, doctor blades and creping blades are used not only to remove material from a passing surface and crepe the material, but also to cut the material, split the material, scrape a surface, clean a surface, control the amount of material coating on a surface, and/or provide a means for controlling the material that is being removed, such as, for example, to provide a directional change or tension point for controlling a moving web. One or more of these functions can be provided by a single blade or can be provided by two or more blades in a manufacturing process. If two or more doctor blades are used, the blades 10 can be the same or differ in their geometry, make-up, or any other attribute as well as their intended use and location in the process.

As used herein “doctor blade” generally refers to a blade that is disposed adjacent to another piece of equipment such that the doctor blade can help remove from that piece of equipment a material that is disposed thereon. Doctor blades are commonly used in many different industries for many different purposes, such as, for example, their use to help remove material from a piece of equipment during a process. Examples of materials include, but are not limited to, tissue webs, paper webs, glue, residual buildup, pitch, and combinations thereof. Examples of equipment include, but are not limited to, drums, plates, Yankee dryers, and rolls. Doctor blades are commonly used in papermaking, nonwovens manufacture, the tobacco industry, and in printing, coating and adhesives processes.

In certain instances, doctor blades are referred to by names that reflect at least one of the purposes for which the blade is being used. For example, as used herein the term “creping blade” refers to a doctor blade used in the papermaking industry to remove a paper web from a drum and to provide some “crepe” or fold to the web. In terms of this application, creping blades have the dual function of removing a web from a piece of equipment, such as, for example a Yankee dryer, and providing the web with crepe. Similarly, the term “cleaning blade” as used herein, refers to a doctor blade used to clean a surface.

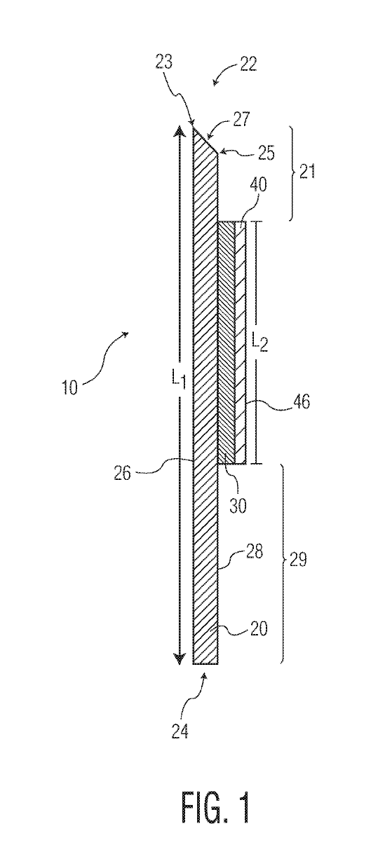

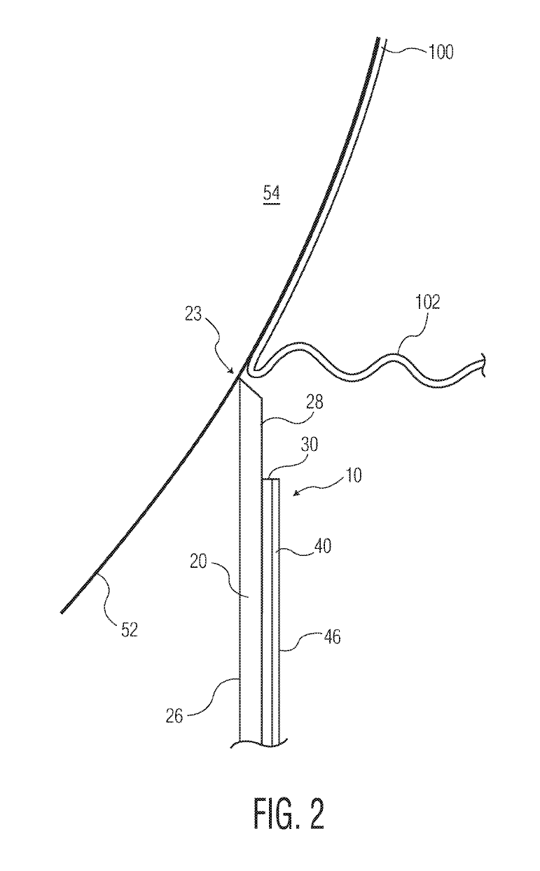

A non-limiting example of creping blades in accordance with the present invention is illustrated in FIG. 1. As illustrated the creping blade 10 comprises a blade 20, a viscoelastic material 30 and a backing layer 40. The blade 20 generally has a first 22 and a second 24 end. The first end 22, also referred to as a working end, is generally the machine contacting end and may comprise a leading edge 23, a trailing edge 25, and a bevel surface 27 there between. The leading edge 23 of the blade 20 is typically disposed closest to the corresponding piece of equipment such as the surface of a drying cylinder (illustrated in detail in FIG. 2). The trailing edge 25 is that portion of the blade that is typically disposed farther from the corresponding equipment from which the material is being removed than the leading edge 23. Thus, the trailing edge 25 is typically located downstream from the leading edge 23 and the bevel surface 27 is located between the leading edge 23 and the trailing edge 25.

The creping blade 10 of FIG. 1 includes a first constraining layer, generally referred to herein as the blade 20 and a second constraining layer, generally referred to herein as the backing layer 40, in opposing relation thereto. A layer of viscoelastic material, generally referred to hereinafter as a viscoelastic layer 30, is disposed between the first and second constraining layers 20, 40, and in a particularly preferred embodiment spans substantially the entirety of (i.e., is coextensive with) the backing layer 40.

The blade 20 may generally be any one of the well-known creping blades in the art. The blade 20 generally comprises a first end 22 defined by a leading edge 23, a trailing edge 25 and a bevel 27. The leading edge 23, trailing edge 25 and bevel 27 generally make up the tip portion 21 of the blade 20. The second end 24 of the blade 20 generally consists of the blade clamping end 29, which is used to fasten and restrain the blade in-use. In one embodiment, such as that illustrated in FIG. 1, the blade clamping end 29 will be substantially free from any viscoelastic material and backing layer. As will be described further below, the blade may be constructed of any suitable material. The durability of the tip may further be improved by adding hard, wear resistant materials, such as a ceramic.

A backing layer 40 is provided over the viscoelastic layer 30 and in a preferred embodiment is coextensive therewith. The backing layer 40, also referred to herein as the second constraining layer, acts in concert with the viscoelastic layer 30 to reduce the vibration generated by the blade 20 during use. Thus, resonant vibration encountered during use causes blade 20 and backing layer 40 to bend and apply a shear force to the viscoelastic layer 30 thereby deforming said layer. Backing layer 40 may be constructed from a variety of materials and be the same material as the blade 20 or be constructed from a different material. By way of example, the blade 20 and back material 40 may be fabricated from steel, more preferably a steel alloy such as carbon steel or stainless steel.

The backing layer 40 generally has a length dimension L2 which is generally less than the height of the blade 20, designated as L1. Thus, it is typical for the backing layer 40 to extend only a portion of the height (L1) of the blade 20. In this manner the tip portion 21 and the blade clamping end 29 of the blade 20 are not covered by the backing layer 40. Similarly, the tip portion 21 and the blade clamping end 29 of the blade 20 are generally not covered by the viscoelastic layer 30. Thus, in certain embodiments L2 is from about 10 to about 80 percent of L1, such as from about 20 to about 70 percent of L1 and still more preferably from about 30 to about 50 percent of L1. It will be understood by one skilled in the art however, that the invention is not so limited and that in certain alternate embodiments the viscoelastic layer and backing layer may extend over a portion or the entirety of the clamping end. Regardless of whether the clamping end comprises a viscoelastic layer and backing layer, the tip portion is entirely free from a viscoelastic layer and backing layer.

With further reference to FIG. 1, the clamping end 29 may be substantially free from a viscoelastic material 30 and backing layer 40. In such embodiments the width of the clamping end 29 is essentially the width of the blade 20 and the dampened blade may be readily used in a blade holder designed to retain a conventional blade. In other embodiments the viscoelastic material 30 and backing layer 40 extend the entire length of the clamping end 29 such that the viscoelastic material 30 and backing layer 40 are retained by the blade holder in use.

Viscoelastic materials useful in dampening vibrations and more specifically vibrations occurring in metallic parts are well known in the art and any suitable viscoelastic may be used in the present invention. In one particularly preferred embodiment the viscoelastic material comprises a silicone rubber. Suitable silicone rubbers may include, for example, a dimethyl siloxane compound, a borosilicone rubber combination with silicone oil, a silicone polymer combination with boric oxide, or a combination thereof, for example. The viscoelastic silicone rubber useful in the present invention may include dense materials, foamed materials, comminuted materials, and materials that can be molded and even incorporated in other known materials to form blended materials and composite materials. In certain embodiments viscoelastic silicone rubbers useful in the present invention are solids having equilibrium shapes to which they return in the absence of imposed stresses. For example, conventional silicone rubber is a solid formed when individual polyorganosiloxane molecules are crosslinked together into an extensive network. The crosslinks have little effect on the short-range mobilities of the individual molecular chains since those chains can still slide across one another at room temperature. However, the crosslinks severely limit the long-range mobilities of those chains. The vast network of linkages, loops, and tangles present in a heavily crosslinked silicone material give that material a fixed equilibrium shape and render it a solid.

In other embodiments the viscoelastic material may comprise silicone-acrylate compounds. For example, the viscoelastic material may comprise from about 5 to about 95 parts by weight of an acrylic monomer and correspondingly from about 95 to about 5 parts by weight of a silicone adhesive. More preferably, the viscoelastic material comprises about 30 to about 95 parts acrylic monomer and, correspondingly, from about 70 to about 5 parts silicone adhesives. The silicone adhesive may comprise the intercondensation product of a silanol functional polydiorganosiloxane and a silanol functional copolymeric silicone resin.

In other embodiments the viscoelastic layer may be comprised of a polymeric acrylic, such as a polymeric acrylic having a viscosity from about 900-1200 Centipoise (cps), more preferably from about 950 to about 1050 cps. Particularly preferred polymeric acrylics comprise copolymers of alkylacrylate and one or more copolymerizable acrylic monomers such as acrylic acid, methacrylic acid, acrylonitrile, methacrylonitrile, acrylamide and methacrylamide. The alkyl acrylate may be a single monomer having from about 6 to 10 carbon atoms in its alkyl group which is not highly branched, that is, more than half of the alkyl carbon atoms are in a straight chain terminating at the oxygen bridge. In the event that the alkyl acrylate is a mixture of monomers, the alkyl group should have an average of about 6 to 10 carbons, and less than half of the alkyl groups should be highly branched.

A particularly preferred polymeric acrylic comprises from about 80 to 95 parts by weight of alkyl acrylate and, correspondingly, from about 20 to 5 parts by weight of one or more of the named copolymerizable acrylic monomers. Most preferably the composition comprises 90 parts by weight of the alkyl acrylate and 10 parts by weight of one or more of the named copolymerizable acrylic monomers. Thus, an example of a particularly preferred viscoelastic layer comprises 90 parts by weight isooctyl acrylate and 10 parts by weight acrylic acid.

Other materials useful in forming the viscoelastic layer comprise a mixture of a polymeric material and a plasticizer. For example, a composition of 100 parts by weight polyvinyl chloride and about 50 parts by weight plasticizer (“Paraplex” G-251) is suitable. Other suitable viscoelastic layers may be prepared from polymers such as polyurethanes and polymethacrylates, when properly plasticized.

The viscoelastic layer may be engineered to retain a predetermined percentage of fastener torque in compression through cross-linking and thereby improve stress relaxation by utilizing a minimal dry film thickness and/or containing inorganic particles for reinforcement. By way of example, the viscoelastic layer may be formulated with an excess of external cross-linking agent—i.e., an amount in excess of a stoichiometric quantity thereof, in order to counteract a reduction in shear adhesion properties upon accelerated aging. The external cross-linking agent is preferably chosen from the family of metal acetylacetonates. By adding a very high excess of external cross-linking agent the depolymerization of the viscoelastic core is not thermodynamically favored.

When the material used to form the viscoelastic layer has pressure sensitive adhesive properties, the material can usually be adhered to the constraining layer without the use of an additional bonding agent. However, in certain instances it may be necessary to use a thin layer (e.g., 20-50 μm) of a high-modulus adhesive, such as an acrylic adhesive or an epoxy adhesive, to bond the viscoelastic material to the constraining layer.

As will be explained further below, the viscoelastic layer 30 is bonded or adhered to the blade 20 and backing layer 40. Sandwiching the viscoelastic layer 30 between the blade 20 and backing layer 40 provides vibration reduction for the creping blade 10 eliminating the need for additional parts or materials to provide damping. For example, without the constrained viscoelastic layer the blade will tend to undergo deformation due to vibrational forces generated by defects in the dryer surface. The vibrational forces not only deform the blade, but may also cause additional damage to the dryer surface. Since the viscoelastic layer 30 is bonded to both blade 20 and backing layer 40 deformation forces exacted along the outer surfaces 26, 46 of the blade 20 and backing layer 40 are transferred to the viscoelastic layer 30. These forces shear across the viscoelastic layer 30 since the layer is constrained by the blade 20 and backing layer 40 which attenuates and absorbs the deformation energy and dissipates it into heat, thereby damping vibrations.

FIG. 2 is a depiction of a portion of an exemplary embodiment of a typical papermaking process including the use of a creping blade 10 to remove a paper web 100 from a drum 54 to yield a creped paper web 102. As shown, the web 100 moves in the machine direction (MD) along the surface 52 of the drum 54 until it impacts the leading edge 23 of the blade 20. In this case, the creping blade 10 removes the web 100 from the drum 54 and also provides “crepe” or micro and/or macro folds in the web 100 before it passes over the trailing edge 25 of the blade 20.

The blade 20 of the present invention can be made from any material or materials suitable for the particular purpose of the blade. For example, the blade may be made from metals, ceramics or composite materials, but can also be made from plastic, carbon, glass, stone or any other suitable material or combination of materials. Similarly, the blade 20 of the present invention can be coated with any material or materials suitable for the particular purpose of the blade, such as materials that improve the durability of the blade. Particularly preferred coatings include sprayed ceramic compounds and more preferably a ceramic of chromia.

Further, the blade 20 may vary in any of its dimensions, such as height, length and/or thickness, as well as bevel angle and the geometry of any side and/or surface of the blade 20. The doctor blade 20 can be a single-use blade or a blade that is reused with or without being reground, refurbished or otherwise restored to allow the blade 20 to be reused after it has been taken out of service for any particular reason. The doctor blade 20 can have only a single working end 22 or can have two or more working ends (for purposes of simplification, the creping blades 10 shown herein have a single working end 22). Further, the doctor blade 20 could have multiple leading edges 23 and trailing edges 25 on any working end 22.

Blades 20 generally have a first length dimension L1 (illustrated in FIG. 1), commonly referred to as the blade height, which may range from about 2 to about 8 inches and more preferably from about 4 to about 6 inches. Of the height, L1, the clamping end 29 may comprise from about 10 to about 50 percent of the height while the tip portion 21 may comprise from about 2 to about 30 percent of the height. The constrained layer will generally comprise from about 10 to about 70 percent, more preferably from about 20 to about 50 percent and still more preferably about 25 to 30 percent of the height (L1) of the blade 20.

Suitable blades 20 for use in the present invention are commercially available from, for example, Btg Eclépens S. A. (Eclépens, Switzerland) and Sandvik A B (Sandviken, Sweden). In certain preferred embodiments the blades 20 are steel, more preferably a steel alloy and still more preferable stainless steel or carbon steel, and have dimensions from about 40 to about 300 inches in length, from about 2 to about 8 inches in height and from about 0.01 to about 0.10 inches in bevel surface length. In another embodiment of the present invention, the blades 20 have a length of from about 100 to about 250 inches. In yet another embodiment, the blades 20 have a length of from about 190 to about 200 inches. In another embodiment, the blades 20 have a height of from about 4 to about 6 inches. In yet another embodiment, the blades have a bevel surface length of from about 0.02 to about 0.08 inches. In still another embodiment, the blades have a bevel surface length of from about 0.04 to about 0.06 inches. The blade 20 can have any bevel angle B, but it has been found that a bevel angle B between about 0 and about 45 degrees may be suitable for tissue and/or towel applications. In another embodiment of the invention, the bevel angle B is between about 15 and about 30 degrees.

The creping blade is generally held in place against the drum by a holder, which generally comprises an elongated holder part and an anchoring part. The holder part is provided with a longitudinal groove (in the form of a slot of adequate depth and width in order to provide satisfactory support and guiding and at the same time to allow for sliding) that either has enough width for the blade to be pulled out and pushed in when being exchanged and/or is provided with means that allow for setting the height and/or width, which positions the creping blade in the holder device. In this manner the holder retains and clamps the blade, but generally does not contact the viscoelastic layer or the backing member. In other embodiments however, the viscoelastic layer may extend along at least a portion of the clamping end and the viscoelastic layer may be retained by the holder in use.

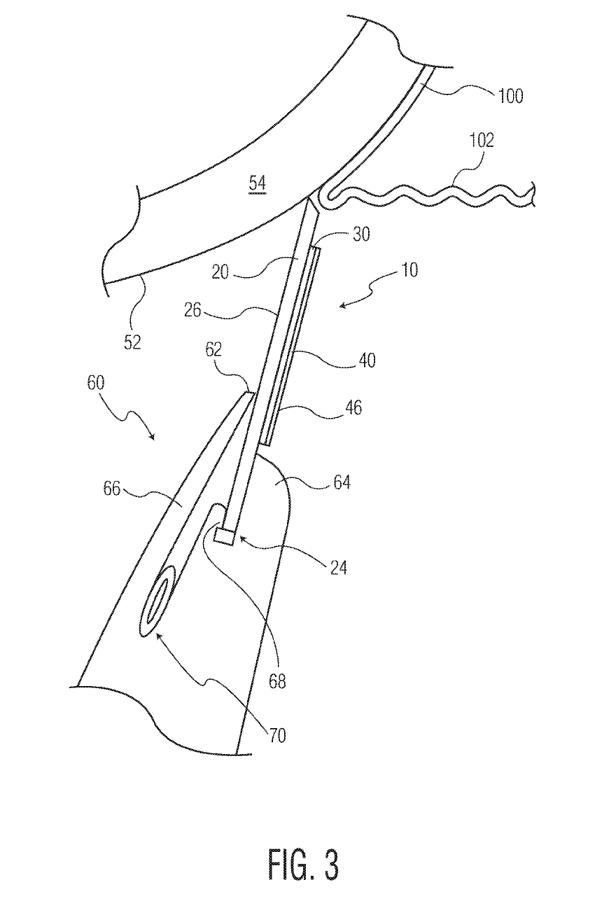

Turning now to FIG. 3, one embodiment of a mounted creping blade according to the present invention is illustrated. The creping assembly is utilized for creping the paper web 100 from the surface 52 of the drum 54. The assembly comprises a creping blade 10 secured in a creping blade holder 60, which positions and secures the creping blade 10 as it is urged against the surface 52 of the drum 54.

The doctor blade holder 60 may be seen to comprise first and second side support bars 64 and 66 on opposite sides of the blade 10. A third support bar 68 is disposed between the bars 64 and 66; and the bars 64, 66 and 68 are fastened together at their bases by a suitable fastening means (not shown) to act as a single assembly. The first support bar 66 may be seen extending upward beyond the second and third support bars 64, 68 and terminating at a distal end 62 that contacts the front surface 26 of the blade 20, further supporting the blade 20 as it is urged against the surface 52 of the drum 54 in-use. The second side support bar 64 terminates immediately adjacent to the end of the viscoelastic layer 30 and back member 40. In this manner neither the viscoelastic layer 30 or the back member 40 are retained in the holder 60.

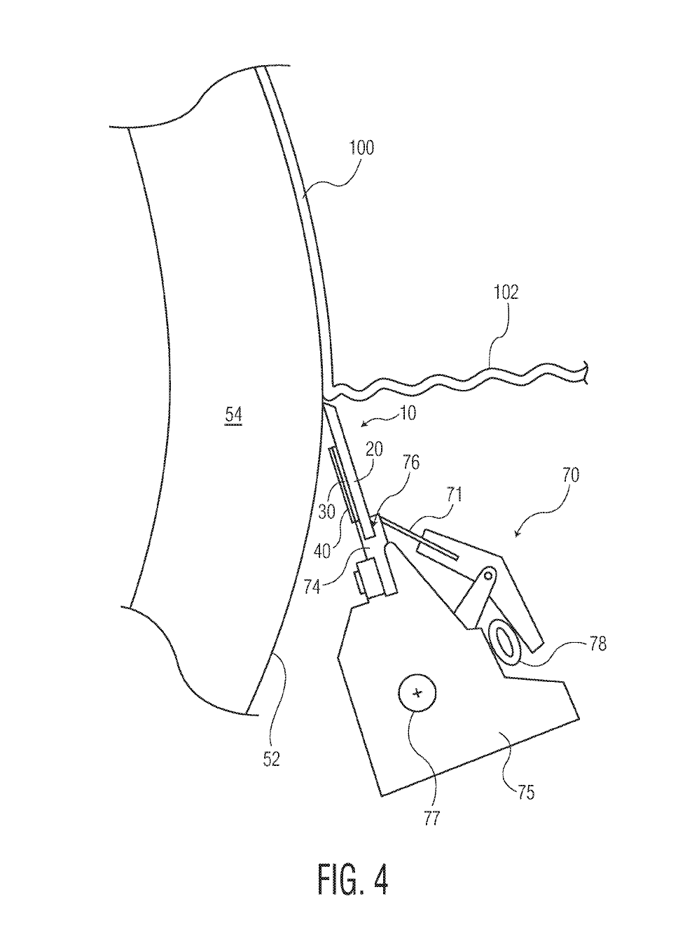

FIG. 4 shows another embodiment of a mounted creping blade according to the present invention. As illustrated, the creping assembly comprises a holder device 70 consisting of an elongated body 75 with anchoring means 77, such as a circular receptacle for receiving a shaft. At the upper portion of the body 75 there is a lip at which a holder part 74 is clamped, such as by a mechanical joint. This holder part 74 provided with an elongated groove 76 shaped to receive the blade claiming portion of the blade 20. In this manner, only the blade claiming portion of the blade 20 is received and retained by the holder part 74. The viscoelastic layer 30 and back member 40 are unrestrained by the holder and more preferably do not contact the holder part 74.

The holder part 74 is further supported by a presser part 71, which generally consists of an elongated body (or a body that is divided/sectioned in its longitudinal direction). A pressing load can be applied against the holder part 74 by the presser part 71 by adjusting the pressure of one or more pressure means 78 (preferably a flexible inflatable hose) that is arranged between the lower portion of the body 75 and the surface of the holder device. Hence, the pressing load can be controlled by aid of said pressurizing means 78, by it pivoting the body about the pivot hinge such that the pressing part 71 affects the pressing load of the blade 10 against the drum 54.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

Accordingly, in a first embodiment the invention provides a creping blade comprising a blade having a tip and a blade clamping end and a length L1, a backing layer having a length L2 and a layer of viscoelastic material disposed between the blade and the backing layer, wherein L1 is greater than L2.

In a second embodiment the invention provides the first embodiment wherein the viscoelastic layer is coextensive with the backing layer.

In a third embodiment the invention provides the first or second embodiments wherein the blade and the backing layer are formed from the same material.

In a fourth embodiment the invention provides any one of the first, second or third embodiments wherein the blade and the backing layer are formed from a steel alloy.

In a fifth embodiment the invention provides anyone of the first through fourth embodiments wherein the viscoelastic layer comprises a polymeric acrylic having a viscosity of about 950 to 1050 Centipoise (cps).

In a sixth embodiment the invention provides any one of the first through fifth embodiments wherein the viscoelastic layer is selected from the group consisting of a silicone rubber, a polymeric silicone-acrylate and polymeric acrylic.

In a seventh embodiment the invention provides any one of the first through sixth embodiments wherein the wherein L2 is from about 10 to about 80 percent of L1.

In an eighth embodiment the invention provides any one of the first through seventh embodiments wherein the clamping end is substantially free from viscoelastic material and has a length from about 5 to about 20 percent of L2.

In a ninth embodiment the invention provides any one of the first through eighth embodiments wherein the blade comprises a steel substrate and the tip is covered by a ceramic top layer that forms a working edge adapted for contacting a web during creping.

In a tenth embodiment the invention provides any one of the first through ninth embodiments wherein the viscoelastic layer is adhered directly to the blade.

In an eleventh embodiment the invention provides a creping apparatus for creping a web of tissue from a creping cylinder comprising a holder and a creping blade comprising a blade having a tip and a blade clamping end and a length L1, a backing layer having a length L2 and a layer of viscoelastic material disposed between the blade and the backing layer, wherein L1 is greater than L2.

In a twelfth embodiment the present invention provides the creping apparatus of the eleventh embodiment wherein the viscoelastic layer is coextensive with the backing layer.

In a thirteenth embodiment the present invention provides the creping apparatus of the eleventh or twelfth embodiment wherein the blade and the backing layer are formed from the same material.

In a fourteenth embodiment the present invention provides the creping apparatus any one of the eleventh through the thirteenth embodiments wherein the viscoelastic layer is selected from the group consisting of a silicone rubber, a polymeric silicone-acrylate and polymeric acrylic.

In a fifteenth embodiment the present invention provides the creping apparatus any one of the eleventh through the fourteenth embodiments wherein L2 is from about 40 to about 60 percent of L1.

In a sixteenth embodiment the present invention provides the creping apparatus any one of the eleventh through the fifteenth embodiments wherein the viscoelastic material and backing layer are coextensive with the entire blade, except the tip.

What is claimed is:

1. A creping blade comprising a blade having a tip and a blade clamping end and a length L1, a backing layer having a length L2 and a layer of viscoelastic material disposed between the blade and the backing layer, wherein L1 is greater than L2.

2. The creping blade of claim 1 wherein the viscoelastic layer is coextensive with the backing layer.

3. The creping blade of claim 1 wherein the blade and the backing layer are formed from the same material.

4. The creping blade of claim 1 wherein the blade and the backing layer are formed from a steel alloy.

5. The creping blade of claim 1 wherein the viscoelastic layer is selected from the group consisting of a silicone rubber, a polymeric silicone-acrylate and polymeric acrylic.

6. The creping blade of claim 1 wherein the viscoelastic comprises a polymeric acrylic having a viscosity of about 950 to 1050 Centipoise (cps).

7. The creping blade of claim 1 wherein L2 is from about 10 to about 80 percent of L1.

8. The creping blade of claim 1 wherein L2 is from about 40 to about 60 percent of L1.

9. The creping blade of claim 1 wherein the clamping end is substantially free from viscoelastic material and has a length from about 5 to about 20 percent of L2.

10. The creping blade of claim 1 wherein the viscoelastic material and backing layer are coextensive with the entire blade, except the tip.

11. The creping blade of claim 1 wherein the blade comprises a steel substrate and the tip is covered by a ceramic top layer that forms a working edge adapted for contacting a web during creping.

12. The creping blade of claim 1 wherein the viscoelastic layer is adhered directly to the blade.

13. The creping blade of claim 1 wherein the viscoelastic layer is adhered directly to the backing layer.

14. A creping apparatus for creping a web of tissue from a creping cylinder comprising a holder and a creping blade comprising a blade having a tip and a blade clamping end and a length L1, a backing layer having a length L2 and a layer of viscoelastic material disposed between the blade and the backing layer, wherein L1 is greater than L2.

15. The creping blade of claim 14 wherein the viscoelastic layer is coextensive with the backing layer.

16. The creping blade of claim 14 wherein the blade and the backing layer are formed from the same material.

17. The creping blade of claim 14 wherein the viscoelastic layer is selected from the group consisting of a silicone rubber, a polymeric silicone-acrylate and polymeric acrylic.

18. The creping blade of claim 14 wherein L2 is from about 40 to about 60 percent of L1.

19. The creping blade of claim 14 wherein the viscoelastic material and backing layer are coextensive with the entire blade, except the tip.

20. A method of reducing creping blade vibration during the creping of a tissue web comprising the steps of providing a creping blade comprising a blade having a tip and a blade clamping end and a length L1, a backing layer having a length L2 and a layer of viscoelastic material disposed between the blade and the backing layer, wherein L1 is greater than L2, retaining the creping blade in a blade holder, conveying a tissue web across the surface of a creping cylinder and urging the creping blade against the surface of the creping cylinder thereby removing the tissue web therefrom with reduced creping blade vibration.
